(19) United States
(12) Patent Application Publication
(10) Pub. No.: US 2025/0068859 A1
(43) Pub. Date: Feb. 27, 2025

(54) METHOD AND SYSTEM FOR DYNAMICALLY CREATING INSTANCE FOR CONTENT OF INFORMATION PROVIDER

(71) Applicant: NAVER CORPORATION, Seongnam-si (KR)

(72) Inventors: Min Kyeam KIM, Seongnam-si (KR); Jae Min AHN, Seongnam-si (KR); Seok Won PARK, Seongnam-si (KR); Sungeun KIM, Seongnam-si (KR); SunYoung HA, Seongnam-si (KR); Jisu SEO, Seongnam-si (KR); Jaeman PARK, Seongnam-si (KR); SaeRom PARK, Seongnam-si (KR); Jinseok LIM, Seongnam-si (KR)

(21) Appl. No.: 18/813,625

(22) Filed: Aug. 23, 2024

(30) Foreign Application Priority Data
Aug. 23, 2023 (KR) 10 2023 0110857
Jan. 10, 2024 (KR) 10 2024 0004165

(51) Int. Cl. G06F 40/40; G06F 16/338; G06F 40/289; G06F 40/35

(52) U.S. Cl. CPC G06F 40/40; G06F 16/338; G06F 40/289; G06F 40/35

(57) ABSTRACT

A method for dynamically creating an instance for content of an information provider includes verifying LLM results created based on a large language model (LLM) for a prompt of a user, creating an instance for content of an information provider using the LLM results and a pre-registered asset of the information provider; and providing the created instance such that the created instance is displayed in relation to the LLM results.

### CROSS-REFERENCE TO RELATED APPLICATION(S)

This U.S. non-provisional application claims the benefit of priority under 35 U.S.C. § 119 to Korean Patent Application No. 10-2023-0110857 filed on Aug. 23, 2023, and Korean Patent Application No. 10-2024-0004165 filed on Jan. 10, 2024, in the Korean Intellectual Property Office (KIPO), the entire contents of which are incorporated herein by reference.

### BACKGROUND OF THE INVENTION

### Field of Invention

One or more example embodiments of the present invention in the following description relate to a method and a system for dynamically creating an instance for content of an information provider.

### Description of Related Art

A large language models (LLM) are a type of artificial intelligence trained with a large corpus of text data to create a human-like response to a natural language input and also a language model with an artificial neural network containing numerous parameters (usually billions of weights or more). This LLM may be trained with a significant amount of unlabeled text using self-supervised learning or semi-self-supervised learning. Reference material includes Korean Patent Registration No. 10-2551531.

### BRIEF SUMMARY OF THE INVENTION

One or more example embodiments of the present invention provide a method and a system for dynamically creating an instance for content of an information provider.

According to at least one example embodiment, there is provided a dynamic content creation method of a computer device having at least one processor, the dynamic content creation method including verifying, by the at least one processor, LLM results created based on a large language model (LLM) for a prompt of a user; creating, by the at least one processor, an instance for content of an information provider using the LLM results and a pre-registered asset of the information provider; and providing, by the at least one processor, the created instance such that the created instance is displayed in relation to the LLM results.

According to an aspect of the present invention, the creating of the instance for the content may include combining the pre-registered asset according to a keyword extracted from the LLM results, a material, a previous conversation between an LLM-based artificial intelligence and the user, and a prompt of the information provider and by modifying at least one of an expression, a format, and a message's tone and manner in the combined asset.

According to another aspect, the creating of the instance for the content may include dynamically creating the instance for the content of the information provider by extracting a plurality of prompts from the LLM results and the asset and by inputting the extracted plurality of prompts into the LLM.

According to still another aspect, the asset may include at least one of a uniform resource locator (URL) related to content that the information provider desires to provide, a title of the content, an identifier of the content, a category of the content, multimedia related to the content, contents of the content, and contents of an article related to the content.

According to still another aspect, the creating of the instance for the content may include using a pre-register prompt of the information provider.

According to still another aspect, the pre-registered prompt may include at least one of a phrase or a keyword entered to emphasize a relation to content that the information provider desires to provide, and a tone or a format of an information message to be provided through the instance for the content.

According to still another aspect, the creating of the instance for the content may include using the prompt of the user.

According to still another aspect, the creating of the instance for the content may include using information on the user, and information on the user may include at least one of the user's demographics, things of interest, and purchase information.

According to still another aspect, the creating of the instance for the content may include using a characteristic and a weight of a target included in a pre-registered prompt of the information provider, and the weight may include at least one of a character-specific weight of the target and a contents-specific weight of the target.

According to still another aspect, the information provider may be dynamically selected through a dynamic auction between information providers related to at least one of the prompt of the user, the LLM results, and a recommendation query created by the large language model among the plurality of information providers.

According to still another aspect, a mode switching function to a mode of providing an answer as the LLM results through a conversation between an LLM-based artificial intelligence module and the user may be provided through a page provided for a search service.

According to still another aspect, when content of a specific brand is exposed through the page provided for the search service, the mode switching function may be provided in conjunction with the content of the specific brand.

According to still another aspect, the mode switching function may be included in at least one recommendation prompt created in association with the specific brand in a form of a link for executing the mode switching function, and the at least one recommendation prompt may be provided through the page in conjunction with the content of the specific brand.

According to still another aspect, the page may include a search result page provided in response to a search term of the user, the mode switching function may be included in at least one recommendation prompt created in association with at least one search result among search results included in the search result page in a form of a link for executing the mode switching function, and the at least one recommendation prompt may be provided through the search result page in conjunction with the at least one result.

According to at least one example embodiment, there is provided a non-transitory computer-readable recording media storing a computer program to execute the dynamic content creation method on the computer device.

According to at least one example embodiment, there is provided a computer device including at least one processor configured to execute instructions readable on the computer device, wherein the at least one processor is configured to verify LLM results created based on a large language model (LLM) for a prompt of a user, to create an instance for content of an information provider using the LLM results and a pre-registered asset of the information provider, and to provide the created instance such that the created instance is displayed in relation to the LLM results.

According to some example embodiments, it is possible to provide a method and a system for dynamically creating an artificial intelligence-based answer to which a message of an information provider is projected.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a block diagram illustrating an example of a computer device according to at least one example embodiment;

FIG. 3 illustrates an example of a dynamic content creation system according to at least one example embodiment;

FIG. 4 is a flowchart illustrating an example of a dynamic content creation method according to at least one example embodiment;

FIG. 5 illustrates an example of a dynamically produced advertising instance according to at least one example embodiment;

FIG. 6 illustrates an example of a process of providing an answer to a prompt of a user according to at least one example embodiment;

FIG. 7 illustrates an example of providing search results according to at least one example embodiment;

FIGS. 8 to 12 illustrate examples of a chat mode that provides an answer as LLM results through conversation between an LLM-based artificial intelligence module and a user according to at least one example embodiment;

FIGS. 13 and 14 illustrate examples of a function for switching to a second mode according to at least one example embodiment; and

FIG. 15 illustrates another example of a function for switching to a second mode according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

A dynamic content creation system according to the example embodiments may be implemented by at least one computer device. Here, a computer program according to an example embodiment may be installed and executed on the computer device that implements the dynamic content creation system, and the computer device may perform a dynamic content creation method according to the example embodiments under the control of the executed computer program. The aforementioned computer program may be stored in a computer-readable storage medium to computer-implement the dynamic content creation method in conjunction with the computer device.

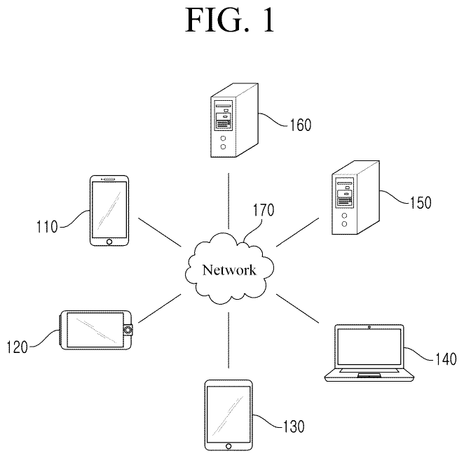

FIG. 1 illustrates an example of a network environment according to at least one example embodiment. Referring to FIG. 1, the network environment may include a plurality of electronic devices 110, 120, 130, 140, a plurality of servers 150, 160, and a network 170. FIG. 1 is provided as an example only. The number of electronic devices or the number of servers is not limited thereto.

Each of the plurality of electronic devices 110, 120, 130, 140 may be a fixed terminal or a mobile terminal that is configured as a computer system. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, 140, and/or the servers 150, 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150, 160 may be configured as a computer device or a plurality of computer devices that provides an instruction, a code, a file, content, a service, etc., through communication with the plurality of electronic devices 110, 120, 130, 140 over the network 170. For example, the server 150 may be a system that provides a first service to the plurality of electronic devices 110, 120, 130, 140 connected over the network 170, and the server 160 may also be a system that provides a second service to the plurality of electronic devices 110, 120, 130, 140. As a detailed example, the server 150 may provide a service (e.g., search service) targeted by a corresponding application to the plurality of electronic devices 110, 120, 130, 140 as the first service through the application as the computer program installed and executed on the plurality of electronic devices 110, 120, 130, 140. As another example, the server 160 may provide a service for distributing a file for installing and executing the aforementioned application to the plurality of electronic devices 110, 120, 130, 140 as the second service.

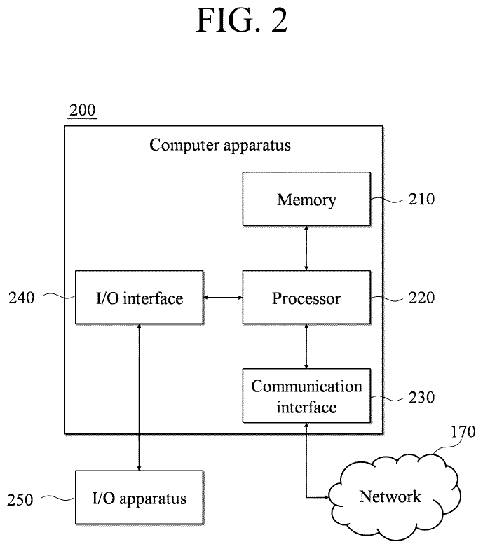

FIG. 2 is a block diagram illustrating an example of a computer device according to at least one example embodiment. Each of the plurality of electronic devices 110, 120, 130, 140 of FIG. 1 or each of the servers 150, 160 may be implemented by a computer device or apparatus 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. Another non-transitory computer-readable record medium separate from the memory 210 may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and another apparatus, for example, the aforementioned storage devices. For example, the processor 220 of the computer device 200 may forward a request or an instruction created based on a program code stored in the storage device such as the memory 210, data, and a file, to other apparatuses over the network 170 under the control of the communication interface 230. Inversely, a signal, instructions, data, a file, etc., from another apparatus may be received at the computer device 200 through the communication interface 230 of the computer device 200. For example, a signal, instructions, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

According to other example embodiments, the computer device 200 may include greater or less number of components than those shown in FIG. 2. For example, the computer device 200 may include at least a portion of the I/O device 250, or may further include other components, for example, a transceiver, a database, etc.

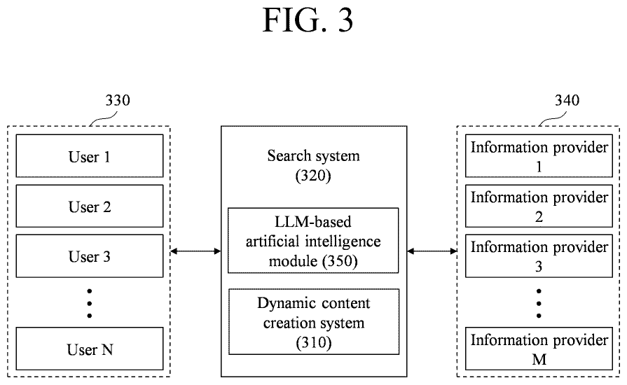

FIG. 3 illustrates an example of a dynamic content creation system according to at least one example embodiment. FIG. 3 illustrates a dynamic content creation system 310, a search system 320, a plurality of users 330, and a plurality of information providers 340.

The search system 320 may correspond to a server (e.g., server 150) that provides a search service to the plurality of users 330, and may be implemented as at least one computer device 200. Here, each of the plurality of users 330 may be a physical device of a user that connects to the search system 320 using the network 170 to receive the search service, and the physical device may be implemented as the aforementioned computer device 200.

The dynamic content creation system 310 according to the example embodiment may be included in the search system 320 or may be implemented to interact with the search system 320 through the network 170. The example embodiment of FIG. 3 illustrates an example in which the dynamic content creation system 310 is included in the search system 320. In this case, the dynamic content creation system 310 may be implemented on at least one physical device to implement the search system 320. Depending on example embodiments, the dynamic content creation system 310 may be implemented as a physical device separate from a physical device that implements the search system 320 and may also be implemented to communicate with the search system 320 through the network 170.

A search service provided by the search system 320 to the plurality of users 330 may include search results corresponding to input of a user. Search results may be basically created based on information that may be searched on the web. Also, the search system 320 may include, in the search results, information that the plurality of information providers 340 desires to provide (instance for content of information provider) and may provide the search service. Here, information provided from the plurality of information providers 340 may be advertising information, but is not limited thereto. The search service that provides search results is already known and thus, a further description is omitted.

The search system 320 according to the example embodiment may provide the search service by including, in search results, answers based on artificial intelligence such as a large language model (LLM). For example, the search system 320 may include an LLM-based artificial intelligence module 350 that performs various processing based on an LLM loaded into a memory of the search system 320 (for example, a memory 210 of a computer device 200 implementing the search system 320). The search system 320 may receive a natural language-based prompt from a specific user among the plurality of users 330. In this case, the search system 320 may input the received prompt into the LLM, may create a first answer suitable for the prompt as LLM results, and may provide search results including the first answer to the user using the LLM-based artificial intelligence module 350. Here, the search results may include at least a portion of various search results in addition to the first answer. Also, the search system 320 may provide the search service through conversation between the LLM-based artificial intelligence module 350 and the user. The search service may be provided to the user while switching between a first mode of providing the first answer as LLM results through a general search service and a second mode of providing the first answer as LLM results through conversation between the LLM-based artificial intelligence module 350 and the user. Here, in the first mode, a user interface for switching to the second mode may be provided, and in the second mode, a user interface for switching to the first mode may be provide. Also, in each of the first mode and the second mode, an instance for content of an information provider may be further provided to at least a portion of the first answer as a second answer. Here, the term “instance” may mean that instances of different structures or contents may be created and provided to users with respect to the same content of the information provider.

Depending on example embodiment, the search system 320 may verify whether a natural language-based prompt received from the user is a user prompt for providing information of the information provider. For example, when the information provider is an advertiser that desires to expose an advertisement of the advertiser, the advertiser may not desire the advertisement to be exposed to a prompt that requests preset illegal information or preset non-advertising information. Therefore, the search system 320 may initially validate whether the prompt of the user is a prompt that is safe to provide information of the information provider. Here, when the prompt of the user is not the prompt that requests the preset illegal information or preset non-advertising information, the search system 320 may request the dynamic content creation system 310 to create and provide the second answer.

The dynamic content creation system 310 may dynamically create an instance for content of an information provider selected from among the plurality of information providers 340. This instance may be created as the artificial intelligence-based second answer to which a message of the corresponding information provider is projected. In this case, the search system 320 may provide the user with search results that include not only the first answer created using the LLM but also the artificial intelligence-based second answer created by the dynamic content creation system 310.

Here, in creating the second answer based on artificial intelligence, the dynamic content creation system 310 may dynamically create the artificial intelligence-based second answer using a prompt of the user, the first answer created using the LLM, an asset registered by the information provider and/or a prompt registered by the information provider, instead of providing information provided from the information provider as is. Here, the asset may include, for example, a uniform resource locator (URL) related to content that the information provider desires to provide, a title or an identifier of the content, a category of the content, multimedia related to the content, contents of the content, and contents of an article related to the content. Here, the multimedia related to the content may include an image and a video related to the content. For example, when the information provider is an advertiser that desires to advertise a specific product or service, the asset may include a URL related to the product or the service, a product name or a service name, a category of the product or the service, product information or service information, and contents of an article related to the product or the service. Also, the prompt registered by the information provider may include information on a phrase or a keyword to emphasize a relation to the content that the information provider desires to provide and a tone or a format of an information message to be provided as the second answer. As such, the dynamic content creation system 310 may dynamically create the second answer that considers the registered asset and the prompt of the information provider desiring to provide his or her information, and the first answer, as well as the first answer created using the LLM for a natural language-based prompt of the user.

Also, depending on example embodiments, the dynamic content creation system 310 may create the second answer by further using information on the user. Here, information on the user may include the user's demographics, things of interest, and purchase information, and may be used to customize the second answer to the user.

In addition, since the plurality of information providers that desires to expose their information may be present, the dynamic content creation system 310 may dynamically determine which information provider's asset and prompt among the plurality of information providers will be used to create the second answer. For example, the dynamic content creation system 310 may primarily select, from among the plurality of information providers, information providers related to the first answer, that is, LLM results based on the first answer. Depending on example embodiments, when primarily selecting the information providers, the dynamic content creation system 310 may use at least one of the prompt of the user, the LLM results, and a recommendation query created by the LLM. Then, the dynamic content creation system 310 may dynamically conduct an auction between the primarily selected information providers and may select a first information provider as an information provider for creating the second answer. A method for the auction may use one of known methods. For example, a generalized second price (GSP) auction method may be used.

As described above, when the search system 320 provides an answer to a natural language-based prompt from the user, the dynamic content creation system 310 may dynamically create an artificial intelligence-based second answer to which an answer dynamically created based on the prompt and the asset of the selected information provider, that is, a message of the information provider is projected. Therefore, the search system 320 may provide the user with the answer dynamically created such that the message of the information provider is projected in relation to the natural language-based prompt received from the user.

Also, depending on example embodiments, contents of the prompt of the user may be insufficient to match information of a specific information provider. In this case, the dynamic content creation system 310 may provide the user with a question for inducing sufficient information for the above matching to be included in the prompt of the user through the search system 320. This question may also be created through the LLM, and information acquired as the answer of the user to the question may also be included in the prompt of the user.

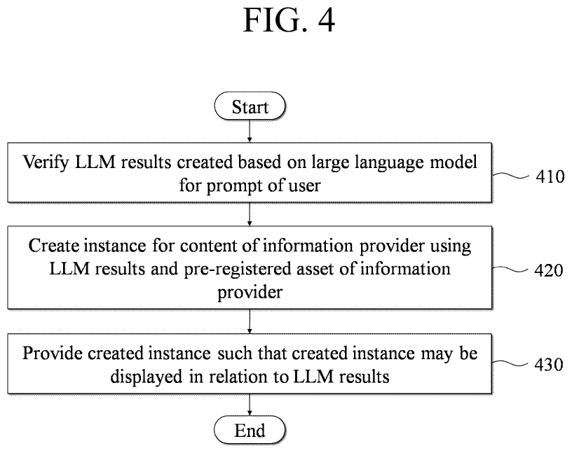

FIG. 4 is a flowchart illustrating an example of a dynamic content creation method according to at least one example embodiment. The dynamic content creation method according to the example embodiment may be performed by the computer device 200 that implements the aforementioned dynamic content creation system 310. Here, the processor 220 of the computer device 200 may be implemented to execute a control instruction according to a code of at least one computer program or a code of an OS included in the memory 210. Here, the processor 220 may control the computer device 200 to perform operations 410 to 430 included in the method of FIG. 4.

In operation 410, the computer device 200 may verify LLM results created based on a large language model (LLM) for a prompt of a user. Here, the prompt of the user may include a query of the user input through a search service provided from the search system 320, but is not limited thereto. For example, the search system 320 may provide a conversation function between the LLM-based artificial intelligence module 350 and the user, and information input from the user through the conversation function may be used as the prompt of the user. In this case, the LLM results created by the search system 320 using the LLM as a response to information input from the user may be verified by the computer device 200 in operation 410. This conversation function may be implemented in a single sub-service form that is included in the search service, or may be implemented in a form linked to the search service as a service separate from the search service.

In operation 420, the computer device 200 may create an instance for content of the information provider using the LLM results and a pre-registered asset of the information provider.

Initially, the information provider may be selected from among the plurality of information providers (e.g., plurality of information providers 340). For example, the computer device 200 may primarily select, from among the plurality of information providers, information providers related to at least one of the prompt of the user, the LLM results, and a recommendation query created by the large language model. For example, the recommendation query may include recommendation prompts that the LLM-based artificial intelligence module 360 can use as input to the LLM. As described above, the primarily selected information providers may include information providers that desire to provide information related to at least one of the prompt of the user, the LLM results, and the recommendation query. For example, the computer device 200 may compare at least one of the prompt of the user, the LLM results, and the recommendation query to each piece of information registered in association with the plurality of information providers and may primarily select information providers having registered information related to at least one of the prompt of the user, the LLM results, and the recommendation query. Then, the computer device 200 may dynamically conduct an auction between the primarily selected information providers and may select a final information provider. For example, the computer device 200 may select the final information provider by conducting a dynamic auction between the primarily selected information providers using a known auction method, such as a GSP auction method.

Also, as described above, the asset may include a uniform resource locator (URL) related to content that the information provider desires to provide, a title or an identifier of the content, a category of the content, multimedia related to the content, contents of the content, and contents of an article related to the content. When the information provider is an advertiser, the advertiser may register various advertising materials as assets. As the assets of advertising materials, various types of data including not only texts, images, and promotional videos related to a product or a service of the advertiser but also news articles, short-form contents, and web document URLs may be registered. Here, the computer device 200 may derive a variety of information related to the advertiser's advertisement, such as a format of data, people and products appearing in the data, a service, a style, and a tone and a manner, through the LLM for the registered asset, and may use the same to produce an instance for the advertiser's advertisement.

Also, depending on example embodiments, the prompt of the information provider may be further used for instance creation. For example, the prompt registered by the information provider may include at least one of a phrase or a keyword entered to emphasize a relation to content that the information provider desires to provide, and a tone or a format of an information message to be provided as an answer. For example, the prompt of the information provider may be pre-registered in such a manner that the search system 320 receives input of the same from the information provider. For example, the search system 320 may provide a registration function for registering an asset and a prompt from the information provider to the information provider. When information provider is an advertiser, the advertiser may use the registration function provided from the search system 320 to enter and input various prompts, such as the purpose of an advertising campaign, a message that the advertiser desires to emphasize, an advertising target, and a value for a desired tone and manner when responding to the advertisement. In this case, the computer device 200 may create an instance for content of the information provider by combining assets of the information provider according to the user's needs and conversation context and according to the prompt of the information provider, in consideration of a keyword and a material of the LLM results and previous conversation between the LLM-based artificial intelligence module 350 and the user and by modifying at least one of an expression, a format, a message tone, and a manner in the combined assets. The material may include the advertising materials as assets. As another example, the computer device 200 may create the instance for content of the information provider by extracting a plurality of prompts from the LLM results and the asset and the prompt of the information provider and by inputting the extracted prompts into the LLM. In this case, the LLM may be trained to create the instance of content of the information provider according to the input plurality of prompts.

The registration function for registering an asset and a prompt from the information provider may be based on a conversation between the LLM-based artificial intelligence module 350 and the information provider. For example, the registration function may provide a function for conversation between the LLM-based artificial intelligence module 350 and the information provider, and the asset and/or the prompt may be registered from the information provider based on contents of the conversation.

Also, depending on example embodiments, the computer device 200 may create an instance customized to the user by creating the instance further using information of a data management platform (DMP) that stores user information, such as the user's gender, age, and things of interest. For example, when user information is determined to be additionally required, a process of asking additional information through an LLM conversation with the user through the search system 320 may be added. For example, in relation to the user's prompt for shoes, the computer device 200 may conduct a conversation between the LLM-based artificial intelligence module 350 and the user through the search system 320 and may provide, to the user, questions, such as “What is your foot size?” and “Do you have wide feet?” Also, the computer device 200 may add an answer of the user to this question as user information and may use the same for instance creation. To this end, a characteristic and a weight of a target may be further included in a pre-registered prompt of the information provider. For example, the characteristic of the target may include demographics (gender, age (or age range)), things of interest, and/or purchase information). For example, the weight may include a characteristic-specific weight of the target and/or contents-specific weight of the characteristic. For example, the characteristic-specific weight may indicate how much weight to be assigned to which characteristic among the target's gender, age, and things of interest. For example, configuration may be made to assign a weight of 5 if the gender is female, to assign a weight of 3 if the age is in the 20s, and to assign a weight of 8 if the thing of interest is exercise. Also, the contents-specific weight may indicate how much weight to be assigned to contents among contents of the same characteristic. For example, if things of interest set by the information provider are exercise, fashion, and games, the information provider may assign a weight of 8 to exercise, a weight of 6 to fashion, and a weight of 2 to games. In this case, the computer device 200 may create the instance for content of the information provider by further using information on the characteristic and the weight of the target. Information on such characteristic and weight of the target may be optionally used when information on the characteristic and the weight of the target is available in the LLM.

In operation 430, the computer device 200 may provide the created instance such that the created instance may be displayed in relation to the LLM results. For example, for the prompt of the user entered as a query such as a search term of the user in a search service, the search system 320 may provide search results that include the LLM results. Here, the created instance may be included in the search results in association with the LLM results and the instance for content of the information provider may be displayed for the user in relation to the LLM results. As another example, in a conversation between the LLM-based artificial intelligence module 350 and the user, even when the LLM results are provided as an answer to the prompt of the user, the instance for content of the information provider may be provided in relation to the provided answer.

Then, the computer device 200 may use the same to improve or modify content of the information provider based on user feedback data. For example, when the information provider is an advertiser, the computer 200 may analyze advertising performance through the user feedback data and may use the same to suggest registration of an additional asset, change of the advertiser's prompt, and the like to the advertiser or to change an advertising instance creation method.

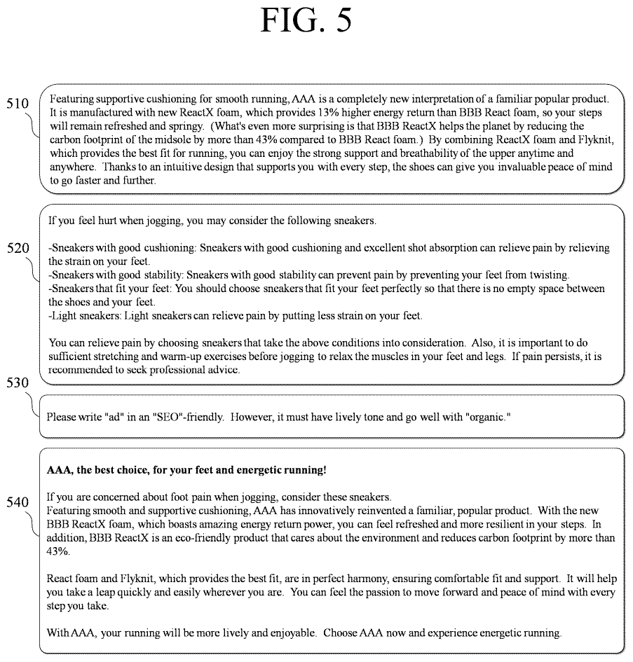

FIG. 5 illustrates an example of a dynamically produced advertising instance according to at least one example embodiment. FIG. 5 shows an example of an advertising instance 540 that is created by considering all of an asset 510 for advertising, LLM results 520 created through an LLM for a prompt of a user, and a prompt 530 of an advertiser. In FIG. 5, “AAA” may represent a product name of the advertiser and “BBB” may represent a brand name of the advertiser. Also, in the prompt 530, “ad” represents advertisement, “SEO” represents search engine optimization, and “organic” represents the LLM results 520. As such, the dynamic content creation system 310 may create the advertising instance 540 based on the LLM by considering all of the LLM results 520 created through the LLM for the prompt of the user and the asset 510 and the prompt 530 that are registered by the advertiser as the information provider. As a detailed example, the dynamic content creation system 310 may create the advertising instance 540 by extracting a plurality of prompts for the LLM from each of the LLM results 520, the asset 510, and the prompt 530, and by inputting the extracted prompts to the LLM.

In the example embodiment of FIG. 5, the asset 510 includes only text and an example in which the advertising instance 540 is created based on the text is described. However, in the case of using a set of assets including various multimedia, such as images and videos, the dynamic content creation system 310 may provide more various types of advertising instances, including images and videos.

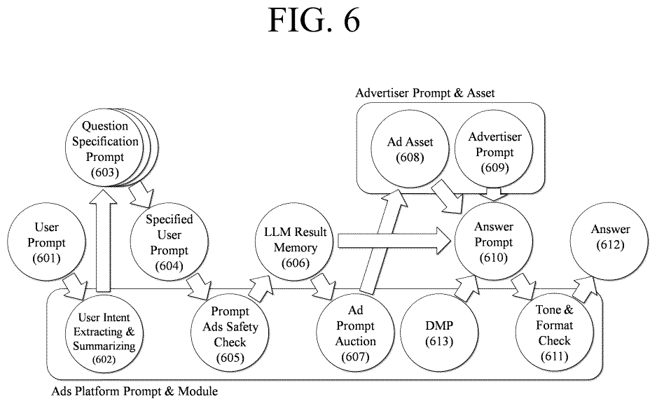

FIG. 6 illustrates an example of a process of providing an answer to a prompt of a user according to at least one example embodiment. The example embodiment of FIG. 6 shows an example of a case in which information providers desire to expose advertising for products or services of advertisers as information they desire to provide.

The search system 320 may receive a user prompt 601 from a terminal of a user connected through the network 170. For example, a prompt may correspond to a natural language-based search term entered from the user. The user may enter a search term through a user interface of a search service provided through the terminal of the user and the search system 320 may receive the search term entered through the user interface as the user prompt 601.

Here, the search system 320 may extract a prompt to be used by analyzing the user prompt 601 and by extracting and summarizing user intent through a process of user intent extracting & summarizing 602.

Meanwhile, the search system 320 and/or the dynamic content creation system 310 may induce the user to provide sufficient information for providing an answer in which a marketing message of an advertiser is reflected. For example, contents of the user prompt 601 may be insufficient to match a marketing message of a specific advertiser. In this case, the dynamic content creation system 310 may create a question for inducing additional information for selection of the specific advertiser and the question created through the search system 320 may be provided to the user. Then, when an answer of the user to the question is received, the prompt may be supplemented using contents of the received answer. A question specification prompt 603 may include the prompt acquired through the answer of the user.

Here, the search system 320 and/or the dynamic content creation system 310 may select a specified user prompt 604 as a prompt for providing the marketing message. That is, the specified user prompt 604 may be specified based on the prompt acquired through the user the intent extracting & summarizing process 602 for the user prompt 601 and the question specification prompt 603.

A prompt ads safety check 605 may be an example of a process of verifying whether the specified user prompt 604 is a prompt that may expose the marketing message of the advertiser to the user. For example, the search system 320 may request the dynamic content creation system 310 to create and provide an answer when the specified user prompt 604 is not a prompt that requests preset illegal information or preset non-advertising information.

Also, the search system 320 may create LLM results by inputting the specified user prompt 604 into an LLM. FIG. 6 shows an example of an LLM result memory 606 that stores the LLM results.

The dynamic content creation system 310 may primarily select advertisers related to the LLM results based on the LLM results stored in the LLM result memory 606. Here, the advertisers related to the LLM results may be advertisers that register marketing messages exposable along with the LLM results. The market messages exposable along with the LLM results may be selected based on relevance between information registered by the advertisers and the LLM results. Also, depending on example embodiments, the dynamic content creation system 310 may use at least one of the specified user prompt 604, the LLM results, and a recommendation query created by the LLM when primarily selecting the advertisers. In this case, the dynamic content creation system 310 may primarily select the advertisers based on relevance between at least one of the specified user prompt 604, the LLM results, and the recommendation query and information registered by at least one advertiser. Here, the dynamic content creation system 310 may select a specific advertiser from among the primarily selected advertisers through an ad prompt auction 607.

When the advertiser is selected, the dynamic content creation system 310 may acquire an ad asset 608 registered by the selected advertiser and an advertiser prompt 609 registered by the selected advertiser. In this case, the dynamic content creation system 310 may create an answer prompt 610 to which the marketing message of the advertiser is reflected using at least one of the user prompt 601 and the LLM results stored in the LLM result memory 606 and at least one of the ad asset 608 and the advertiser prompt 609.

Depending on example embodiments, the advertiser may desire to provide an answer in a specific format according to characteristics of the user. To this end, the dynamic content creation system 310 may create the answer prompt 610 by further reflecting information on the user. For example, information on the user may include at least one of the user's demographics, things of interest, and purchase information. For example, the dynamic content creation system 310 may analyze the advertiser prompt 609 and may verify that the advertiser desires to provide a more detailed answer to a female user than to a male user. In this case, the dynamic content creation system 310 may identify a gender of the user through the user's demographics and may create the answer prompt 610 in consideration of the identified gender of the user.

Once the answer prompt 610 is created, the dynamic content creation system 310 may verify whether the created answer prompt 610 is suitable for a tone and/or a format verified through the advertiser prompt 609, that is, may perform tone & format check 611. If the created answer prompt 610 does not match a tone and/or a format desired by the advertiser, the answer prompt 610 may be processed to be suitable for the tone and/or the format desired by the advertiser. Also, depending on example embodiments, the dynamic content creation system 310 may additionally verify whether the created answer prompt 610 is safe to be exposed.

Then, the dynamic content creation system 310 may provide a finally created answer 612 to the user through the search system 320. For example, the search system 320 may add the answer 612 provided by the dynamic content creation system 310 to the search results and may provide the same to the user through the search service. Also, depending on example embodiments, user information (e.g., gender, age, things of interest, etc.) stored in a data management platform (DMP) 613 may be further used to create the answer prompt 610. By using this user information, the search system 320 may create the answer 612 optimized for the user.

To efficiently utilize the DMP 613, the advertiser prompt 609 may further include information on a characteristic and a weight of a target. For example, the characteristic of the target may include demographics (gender, age (or age range)), things of interest, and/or purchase information). For example, the weight may include a characteristic-specific weight of the target and/or contents-specific weight of the characteristic. For example, the characteristic-specific weight may indicate how much weight to be assigned to which characteristic among the target's gender, age, and things of interest. For example, configuration may be made to assign a weight of 5 if the gender is female, to assign a weight of 3 if the age is in the 20s, and to assign a weight of 8 if the thing of interest is exercise. Also, the contents-specific weight may indicate how much weight to be assigned to contents among contents of the same characteristic. For example, if things of interest set by the advertiser are exercise, fashion, and games, the advertiser may assign a weight of 8 to exercise, a weight of 6 to fashion, and a weight of 2 to games through the advertiser prompt 609. In this case, the dynamic content creation system 310 may create the answer prompt 610 by further using information on the characteristic and weight of the target desired by the advertiser, included in the advertiser prompt 609. Information on such characteristic and weight of the target may be optionally used when information on the characteristic and the weight of the target is available in the LLM.

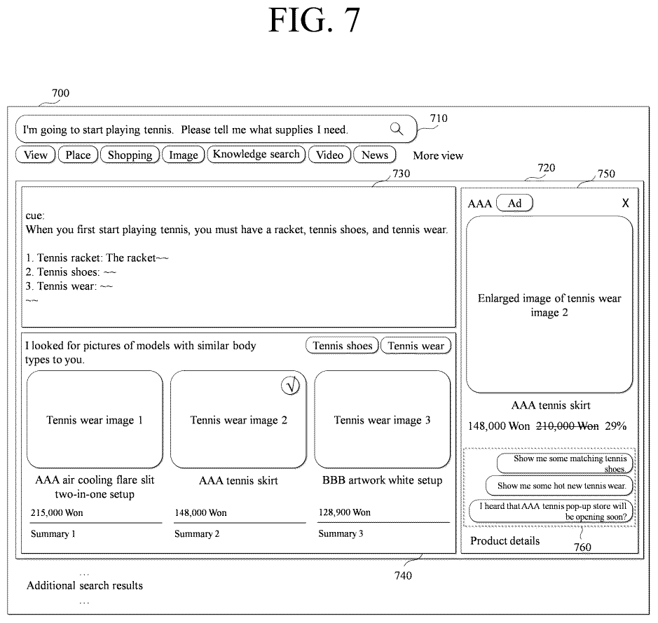

FIG. 7 illustrates an example of providing search results according to at least one example embodiment. FIG. 7 shows an example of a screen of a search page 700 provided to a user through a search service. The search page 700 may include a user interface 710 for receiving a prompt of the user as input. Also, the search page 700 may include a search result area 720 for displaying search results. Here, the search result area 720 may include an LLM result area 730 for displaying the LLM results created based on a large language model (LLM) for the prompt of the user.

Also, the search result area 720 shows an example of an answer area 740 for displaying an answer created by the dynamic content creation system 310 for the prompt of the user. The example embodiment represents an example in which a plurality of answers is displayed through the answer area 740. As such, a plurality of answers may be created and displayed for a single prompt. Also, answers for each of two or more information providers may be created and displayed. To this end, the dynamic content creation system 310 may select two or more information providers.

The example embodiment of FIG. 7 shows an example in which an answer of the information provider selected based on the prompt of the user entered into the user interface 710 and/or LLM results displayed in the LLM result area 730 is displayed through an extended area 750. For example, the answer of the information provider selected based on at least one of the prompt of the user, the LLM results, and a recommendation query created by an LLM may be further displayed in the extended area 750. If the information provider is an advertiser, ad of the advertiser selected based on the prompt of the user, the LLM results, and the recommendation query created by the LLM may be further displayed in the extended area 750.

Also, questions as prompts for requesting an additional prompt of the user in relation to the answer displayed in the extended area 750 may be displayed in a box 760 indicated with dotted lines. When the user selects a specific question, the corresponding question is recognized as the additional prompt of the user. In the case of providing a conversational search service, the additional prompt of the user may be recognized as a subsequent conversation of the user. In this case, the search system 320 and/or the dynamic content creation system 310 may create LLM results and/or answer in consideration of the entire conversation with the user.

Also, although the example embodiment of FIG. 7 describes an example of receiving the prompt of the user as input through the user interface 710 of the search service and dynamically creating an answer, an interface for creating and providing a dynamic answer may also be included in the search results depending on example embodiments. For example, a function for receiving a prompt of a user through each of and/or some of various vertical services provided in the conventional search ecosystem and dynamically creating and providing an answer may be provided to the user. Here, the vertical service may refer to a service for each of various collections that classify search results, such as shopping search, knowledge search, local search, user generated contents (UGC) search, language search, image search, video search, and new search. For example, in the case of separately providing a shopping search service as a vertical service of an integrated search service, a function for receiving a prompt of a user as input and dynamically creating and providing an answer may be provided to the user through the shopping search service. If a plurality of different advertising services is provided as a vertical service of the integrated search service, the function for receiving the prompt of the user as input and dynamically creating and providing the answer may be provided to the user through each of the plurality of advertising services.

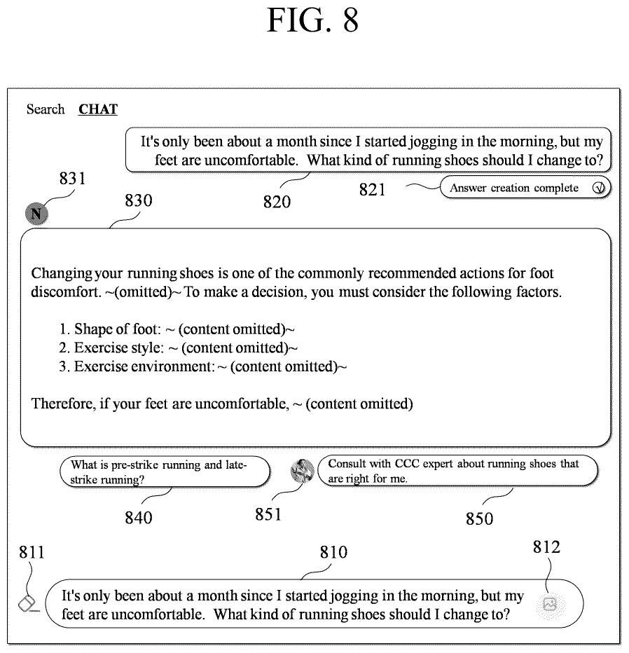

FIGS. 8 to 12 illustrate examples of a chat mode that provides an answer as LLM results through conversation between the LLM-based artificial intelligence module 350 and a user according to at least one example embodiment. This chat mode may correspond to the aforementioned second mode.

The example embodiment of FIG. 8 shows an input interface 810 for receiving a prompt of a user as input. The input interface 810 may be linked to a virtual keyboard function that allows the user to enter text and/or a function for delivering the text input through the input interface 810 to the search system 320. Also, a session initialization interface 811 for initializing a current conversation session may be provided. The session initialization interface 811 may be linked to a function for requesting the search system 320 to initialize the current conversation session to start a new conversation session. Although the example embodiment of FIG. 8 shows an example in which the session initialization interface 811 in a shape of a specific icon is provided on the left of the input interface 810, a shape or a type (icon, button, link, etc.), a position, etc., of the session initialization interface 811 may be variously configured depending on example embodiments. Also, a multimedia input interface 812 for receiving multimedia, such as an image and a video, in addition to the text, as the prompt of the user may be provided. The multimedia input interface 812 may be linked to a function for selecting and delivering multimedia data stored in a terminal of the user or to deliver multimedia data created through a camera included in the terminal of the user.

The example embodiment of FIG. 8 further shows a first area 820 in which the prompt of the user delivered to the search system 320 through the input interface 810 is displayed in a form of a message for conversation. Also, in association with the first area 820, a second area 821 for displaying the progress of a process of creating an answer to the prompt of the user is present. The progress of the process of creating the answer may include, for example, a “search” process, a “search results analysis” process, a process of “reviewing whether further search is required,” and an “answer creation complete” process, but is not limited thereto. In the example embodiment of FIG. 8, the second area 821 shows the “answer creation complete” process. Also, the example embodiment shows a third area 830 on which the answer created for the prompt of the user is displayed. Here, an icon 831 representing an entity that provides the answer may be displayed in association with the third area 830. For example, the icon 831 may include information available to identify the search system 320.

Also, the search system 320 may further provide a first recommendation prompt 840 to the user. In this case, the first recommendation prompt 840 may be used as a prompt of the user in such a simple manner that the user selects the first recommendation prompt 840, and the user may continue the next conversation with the artificial intelligence in a current conversation session. Also, the search system 320 may further provide a second recommendation prompt 850 for conversation with a specific information provider to the user. Here, an icon 851 for displaying the corresponding information provider in association with the second recommendation prompt 850 may be displayed in association with the second recommendation prompt 850. For example, the icon 851 may include information, such as an image, text, etc., related to the information provider.

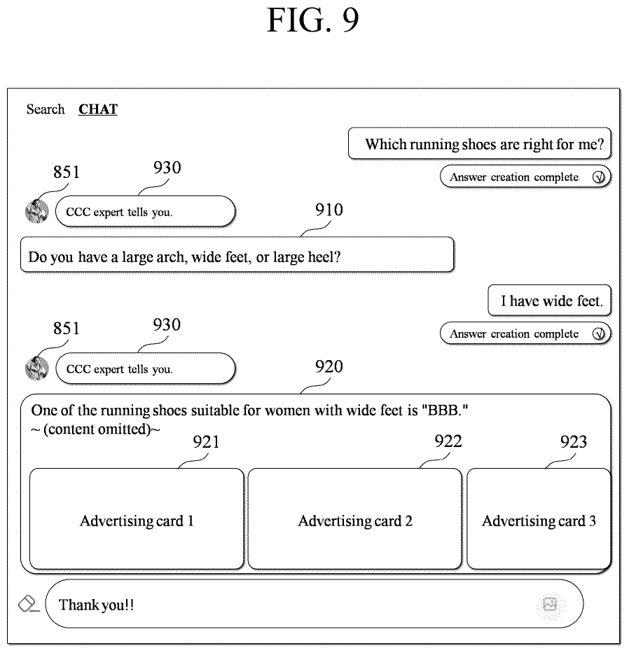

The example embodiment of FIG. 9 shows an example in which, in response to the second recommendation prompt 850 being selected by the user in FIG. 8, conversation with the user proceeds through artificial intelligence specialized for the specific information provider. Here, the artificial intelligence specialized for the specific information provider may also be artificial intelligence provided by the search system 320 based on the LLM. Depending on example embodiments, that the artificial intelligence specialized for the specific information provider is registered to the search system 320 by the specific information provider or is provided by the specific information provider may also be considered. Here, information 930 notifying that a corresponding answer 910, 920 is provided by the specific information provider may be displayed in the answer 910, 920 provided from the artificial intelligence specialized for the specific information provider, and the icon 851 for the corresponding information provider may be further displayed. As described above, the answers 910 and 920 may be dynamically created answers that reflect information (e.g., asset, prompt, etc.) registered in association with the corresponding information provider. Advertising cards (advertising card 1 921, advertising card 2 922, and advertising card 3 923) included in the answer 920 may be produced in a form that includes each product image and product description (product identifier, price, etc.).

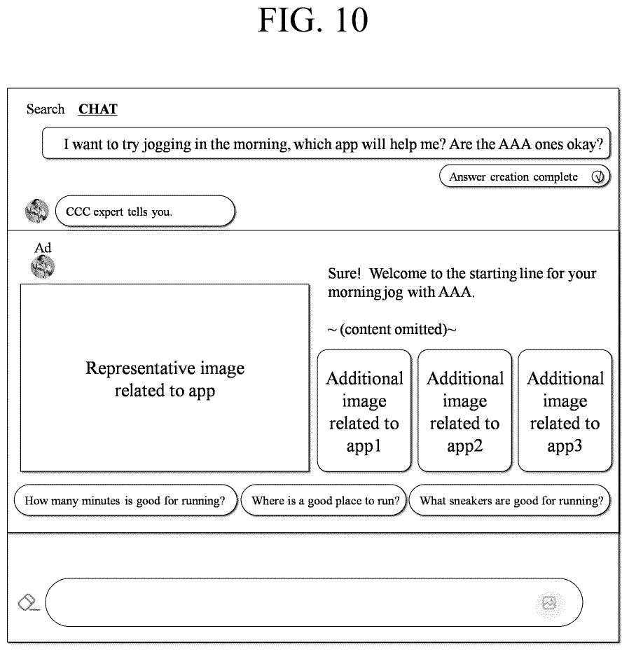

The example embodiment of FIG. 10 shows an example of providing an answer dynamically created for an app advertisement of a specific information provider to a prompt of a user for app recommendation. Here, the example embodiment of FIG. 10 shows an example of dynamically creating and providing an answer of specific brand content in a generative search experience (SGE) style.

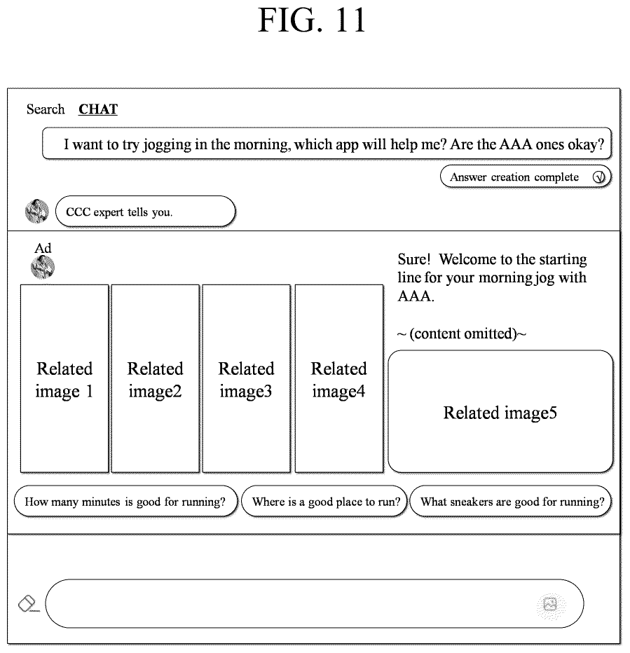

The example embodiment of FIG. 11 shows an example of dynamically creating and providing an answer of an information provider in a different format of a generative search experience (SGE) style to a prompt of the same user as in FIG. 10. As such, the answer of the information provider may be dynamically created and provided in various formats and contents to the prompt.

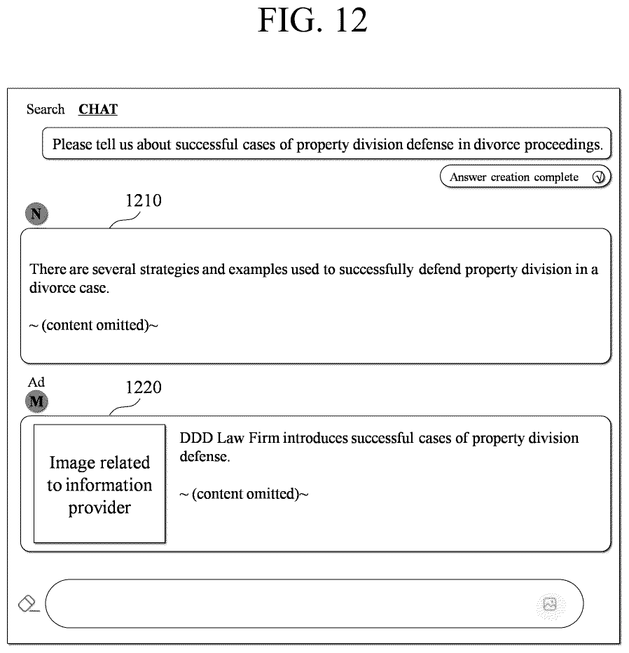

The example embodiment of FIG. 12 shows an example of providing an answer of an information provider during conversation with artificial intelligence as if it were another user in a group chatroom. That is, as an answer 1220 of the information provider is provided in a conversation form separate from an answer 1210 of the artificial intelligence, a user may have experience as if the user converses with two or more other users in a group chatroom.

It is described above that a search service may be provided to the user while switching between a first mode of providing a first answer as LLM results through a general search service and a second mode of providing the first answer as LLM results through conversation between the LLM-based artificial intelligence module 350 and the user. Depending on example embodiments, a function for switching to the second mode may be provided even through the search service that does not provide the LLM results.

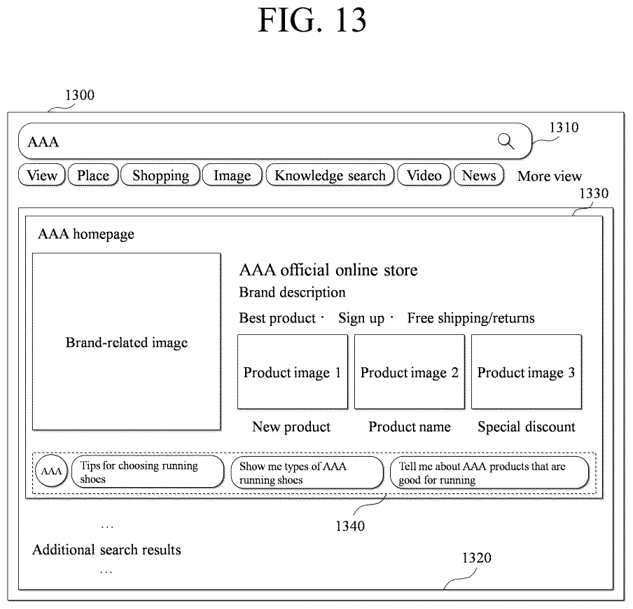

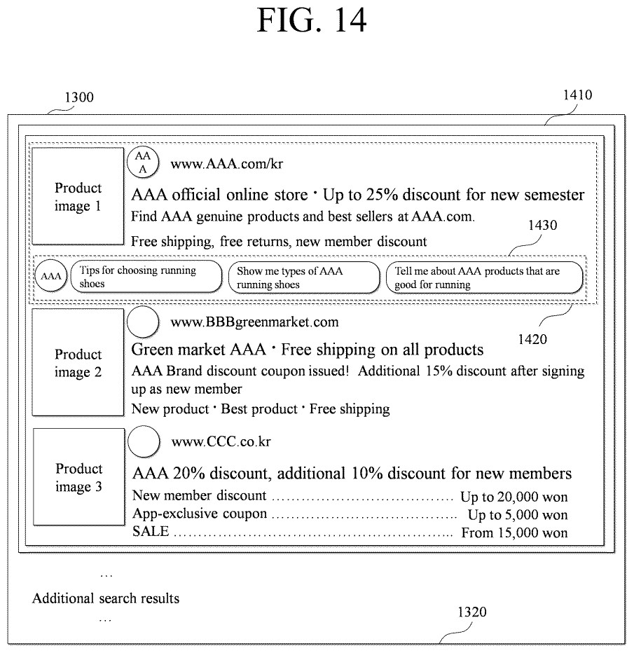

FIGS. 13 and 14 illustrate examples of a function for switching to a second mode according to at least one example embodiment. In example embodiments of FIGS. 13 and 14, search results of various categories may be provided in relation to a search term of a user and, in this case, an example of providing the function for switching to the second mode for each of various categories is described.

The example embodiment of FIG. 13 shows a portion of a search page 1300 provided to the user through a search service. The search page 1300 may include a user interface 1310 for receiving the search term of the user. Also, the search page 1300 may include a search result area 1320 for displaying search results. Here, search results for various categories may be displayed in the search result area 1320. The example embodiment of FIG. 13 shows an example of providing search results 1330 specified for a corresponding brand as one of the search results of various categories in response to the user entering a brand name “AAA” of a specific brand as the search term. Here, the function for switching to the second mode may be provided in conjunction with the search results 1330. The example embodiment of FIG. 13 shows an example of presenting recommendation prompts related to the corresponding brand as shown in a box 1340 indicated with dotted lines. Here, a link with a mode switching function may be set to each of the recommendation prompts. If the user selects one of the presented recommendation prompts, the second mode of providing the first answer as the LLM results through the conversation between the LLM-based artificial intelligence module 350 and the user may be provided to the user using a link set to the selected recommendation prompt. Here, the selected recommendation prompt may be used as the prompt of the user in the second mode.

The example embodiment of FIG. 14 shows an example of displaying search results 1410 of other categories of the search result area 1320 as another portion of the search page 1300. Here, the function for switching to the second mode may be provided in conjunction with individual search results 1420 related to the entered search term. The example embodiment of FIG. 14 shows an example of presenting recommendation prompts related to the individual search results 1420 as shown in a box 1430 indicated with dotted lines. If the user selects one of the presented recommendation prompts, the second mode of providing the first answer as the LLM results through conversation between the LLM-based artificial intelligence module 350 and the user may be provided to the user using the selected recommendation prompt as the prompt of the user.

In the example embodiments of FIGS. 13 and 14, the function for switching to the second mode is provided through the recommendation prompt. However, depending on example embodiments, the function for switching to the second mode may be provided through an icon or a link. Also, depending on example embodiments, the function for switching to the second mode may be provided in conjunction with the entire search page 1300 rather than specific search results. For example, the function for switching to the second mode may be provided through an icon overlaid on a specific area of a screen, regardless of scrolling of the search page 1300.

Also, although it is not a service for providing search results, the function for switching to the second mode may be provided in conjunction with contents in various services depending on example embodiments. For example, the function for switching to the second mode may be provided through content related to the specific brand (e.g., display advertisement (DA) associated with corresponding brand or product or service of the corresponding brand) exposed through various vertical services.

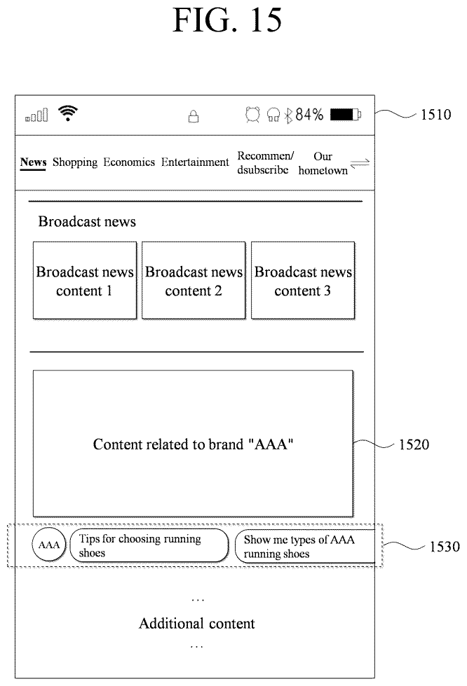

FIG. 15 illustrates another example of a function for switching to a second mode according to at least one example embodiment. Referring to FIG. 15, as an example of a mobile screen 1510 on which a page for providing news content is displayed, content 1520 related to brand “AAA” is provided with news content through the corresponding page. In this case, recommendation prompts each including the function for switching to the second mode may be provided as shown in a box 1530 indicated with dotted lines in conjunction with the content 1520 related to brand “AAA.”

As described above, according to example embodiments, there may be provided a method and a system for dynamically creating an artificial intelligence-based answer to which a message of an information provider is projected.

The systems or apparatuses described herein may be implemented using hardware components, or a combination of hardware components and software components. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, or a computer storage medium or device to provide instructions or data to or to be interpreted by the processing device. The software also may be distributed over network coupled computer systems so that the software is stored and executed in a distributed fashion. The software and data may be stored by one or more computer readable storage mediums.

The methods according to the example embodiments may be implemented in the form of program instructions executable through various computer methods and recorded in non-transitory computer-readable recording media. The media may include, alone or in combination with program instructions, data files, and data structures. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially for storing and performing program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of a program instruction include an advanced language code executable by a computer using an interpreter as well as a machine language code produced by a compiler.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A dynamic content creation method of a computer device having at least one processor, the dynamic content creation method comprising:
verifying, by the at least one processor, LLM results created based on a large language model (LLM) for a prompt of a user;
creating, by the at least one processor, an instance for content of an information provider using the LLM results and a pre-registered asset of the information provider; and
providing, by the at least one processor, the created instance such that the created instance is displayed in relation to the LLM results.

2. The dynamic content creation method of claim 1, wherein the creating of the instance for the content comprises combining the pre-registered asset according to a keyword extracted from the LLM results, a material, a previous conversation between an artificial intelligence module based on the LLM and the user, and a prompt of the information provider and modifying at least one of an expression, a format, and a tone and manner of a message in the combined asset.

3. The dynamic content creation method of claim 1, wherein the creating of the instance for the content comprises extracting a plurality of prompts from the LLM results and the asset of the information provider and inputting the extracted plurality of prompts into the LLM.

4. The dynamic content creation method of claim 1, wherein the asset of the information provider includes at least one of a uniform resource locator (URL) related to content that the information provider desires to provide, a title of the content, an identifier of the content, a category of the content, multimedia related to the content, contents of the content, and contents of an article related to the content.

5. The dynamic content creation method of claim 1, wherein the creating of the instance for the content comprises using a pre-register prompt of the information provider.

6. The dynamic content creation method of claim 5, wherein the pre-registered prompt includes at least one of a phrase or a keyword entered to emphasize a relation to content that the information provider desires to provide, and a tone or a format of an information message to be provided through the instance for the content.

7. The dynamic content creation method of claim 1, wherein the creating of the instance for the content comprises using the prompt of the user.

8. The dynamic content creation method of claim 1, wherein the creating of the instance for the content comprises using information on the user, and information on the user includes at least one of the user's demographics, things of interest, and purchase information.

9. The dynamic content creation method of claim 8, wherein the creating of the instance for the content further comprises using a characteristic and a weight of a target included in a pre-registered prompt of the information provider, and the weight includes at least one of a character-specific weight of the target and a contents-specific weight of the target.

10. The dynamic content creation method of claim 1, wherein the information provider is selected through an auction between information providers related to at least one of the prompt of the user, the LLM results, and a recommendation query created by the large language model among the plurality of information providers.

11. The dynamic content creation method of claim 1, further comprising providing a mode switching function to a mode of providing an answer as the LLM results through a conversation between an artificial intelligence module based on the LLM and the user through a page provided for a search service.

12. The dynamic content creation method of claim 11, wherein, when content of a specific brand is exposed through the page provided for the search service, the mode switching function is provided in conjunction with the content of the specific brand.

13. The dynamic content creation method of claim 12, wherein the mode switching function is included in at least one recommendation prompt created in association with the specific brand in a form of a link for executing the mode switching function, and the at least one recommendation prompt is provided through the page in conjunction with the content of the specific brand.

14. The dynamic content creation method of claim 11, wherein the page provided for the search service includes a search result page provided in response to a search term of the user,
the mode switching function is included in at least one recommendation prompt created in association with at least one search result among search results included in the search result page in a form of a link for executing the mode switching function, and
the at least one recommendation prompt is provided through the search result page in conjunction with the at least one result.

15. A non-transitory computer-readable recording media storing a computer program for executing the dynamic content creation method of claim 1 on the computer device.

16. A computer device comprising:
at least one processor configured to execute instructions stored on a memory,
wherein the at least one processor is configured to,
verify LLM results created based on a large language model (LLM) for a prompt of a user,
create an instance for content of an information provider using the LLM results and a pre-registered asset of the information provider, and
provide the created instance such that the created instance is displayed in relation to the LLM results.

17. The computer device of claim 16, wherein, the instance for the content is created by combining the pre-registered asset according to a keyword extracted from the LLM results, a material a previous conversation between an artificial intelligence module based on the LLM and the user, and a prompt of the information provider and by modifying at least one of an expression, a format, and a tone and manner of a message in the combined asset.

18. The computer device of claim 16, wherein, the instance for the content is created by extracting a plurality of prompts from the LLM results and the asset of the information provider and by inputting the extracted plurality of prompts into the LLM.

19. The computer device of claim 16, wherein the asset of the information provider includes at least one of a uniform resource locator (URL) related to content that the information provider desires to provide, a title of the content, an identifier of the content, a category of the content, multimedia related to the content, contents of the content, and contents of an article related to the content.

20. The computer device of claim 16, wherein the at least one processor is further configured to provide a mode switching function to a mode of providing an answer as the LLM results through a conversation between the LLM-based artificial intelligence and the user through a page provided for a search service.
